(19) United States
(12) Patent Application Publication
(10) Pub. No.: US 2014/0153047 A1
(43) Pub. Date: Jun. 5, 2014

(54) INFORMATION PROCESSING APPARATUS, INFORMATION PROCESSING SYSTEM, AND INFORMATION PROCESSING METHOD

(71) Applicant: Ayako TSUSHIMA, Kanagawa (JP)

(72) Inventor: Ayako TSUSHIMA, Kanagawa (JP)

(73) Assignee: Ricoh Company, Ltd., Tokyo (JP)

(21) Appl. No.: 14/084,754

(22) Filed: Nov. 20, 2013

(30) Foreign Application Priority Data
Dec. 5, 2012 (JP) 2012-266571

(51) Int. Cl. G06F 3/12

(52) U.S. Cl. CPC G06F 3/1296
USPC 358/1.15

(57) ABSTRACT

An information processing apparatus may include an accepting part that accepts an execution instruction of a process having a first time specified in a first time zone, a computing part configured to compute a second time in the first time zone at the first time in a second time zone, based on a time difference between a standard time of the second time zone at which the process is to be executed and a standard time of the first time zone, and an executing part that executes the process when the second time arrives in the first time zone.

### CROSS-REFERENCE TO RELATED APPLICATIONS

This application is based upon and claims the benefit of priority of Japanese Patent Application No. 2012-266571, filed on Dec. 5, 2012, the entire contents of which are incorporated herein by reference.

### BACKGROUND OF THE INVENTION

1. Field of the Invention

The present invention relates to an information processing apparatus, an information processing system, and an information processing method. The present invention also relates to a non-transitory computer-readable storage medium having stored therein a program which, when executed by a computer, causes the computer to perform an information processing process.

2. Description of the Related Art

Conventionally, there is a computer system (hereinafter also referred to as a “equipment management system”) in which an equipment management server centrally manages, via a network, a plurality of image forming apparatuses that are set up in an office or the like. The equipment management system may execute a task that puts a load on the network or the image forming apparatuses, such as collecting states of use of the image forming apparatuses, updating firmware, and the like. The equipment management system may also execute a task that requires rebooting of the image forming apparatuses. Normally, such tasks of the equipment management system are scheduled to be executed during a time when the general users do not access the network and the image forming apparatuses, such as at during the night, during the weekend, and the like. Because it is troublesome to set the schedule of the tasks with respect to each of the image forming apparatuses separately, the task schedule may be set with respect to the plurality of image forming apparatuses in one setting operation.

However, in a case in which a time zone of a location where the image forming apparatus is located and a time zone of a location where the equipment management server is provided are different, an operator must compute a time in the time zone of the image forming apparatus corresponding to night or the like in order to set the computed time in the equipment management server. In addition, when the task schedule is set with respect to a plurality of image forming apparatuses located at mutually different time zones in one operation, the task may be executed while the general user is accessing the image forming apparatus for some of the time zones. In this case, while the general user is accessing the image forming apparatus in these time zones, the load on the network may increase, the process of the image forming apparatus may slow down, and the image forming apparatus may reboot.

The applicant is aware of Japanese Laid-Open Patent Publication No. 2006-513466.

### SUMMARY OF THE INVENTION

Accordingly, it is a general object in one embodiment of the present invention to provide a novel and useful information processing apparatus, information processing system, information processing method, and a computer-readable storage medium, in which the problem described above may be suppressed.

Another and more specific object in one embodiment of the present invention is to simplify an operation of setting a schedule of a process that is to be executed spanning time zones.

According to one aspect of the present invention, an information processing apparatus may include an accepting part configured to accept an execution instruction of a process having a first time specified in a first time zone; a computing part configured to compute a second time in the first time zone at the first time in a second time zone, based on a time difference between a standard time of the second time zone at which the process is to be executed and a standard time of the first time zone; and an executing part configured to execute the process when the second time arrives in the first time zone.

Other objects and further features of the present invention will be apparent from the following detailed description when read in conjunction with the accompanying drawings.

### BRIEF DESCRIPTION OF THE DRAWINGS

FIG. 1 is a block diagram illustrating an example of a configuration of an equipment management system in one embodiment of the present invention;

FIG. 2 is a block diagram illustrating an example of a hardware configuration of an equipment communication server in one embodiment of the present invention;

FIG. 3 is a block diagram illustrating an example of a functional configuration of an operation server in one embodiment of the present invention;

FIG. 4 is a block diagram illustrating an example of a functional configuration of the equipment communication server in one embodiment of the present invention;

FIG. 5 is a flow chart for explaining an example of a processing procedure executed by the operation server;

FIG. 6 is a diagram illustrating an example of a display on a task setting screen;

FIG. 7 is a diagram illustrating an example of a configuration of a task information storage part;

FIG. 8 is a flow chart for explaining an example of a processing procedure executed by the equipment communication server; and

FIG. 9 is a flow chart for explaining an example of a processing procedure of a start time correction process.

### DESCRIPTION OF THE PREFERRED EMBODIMENTS

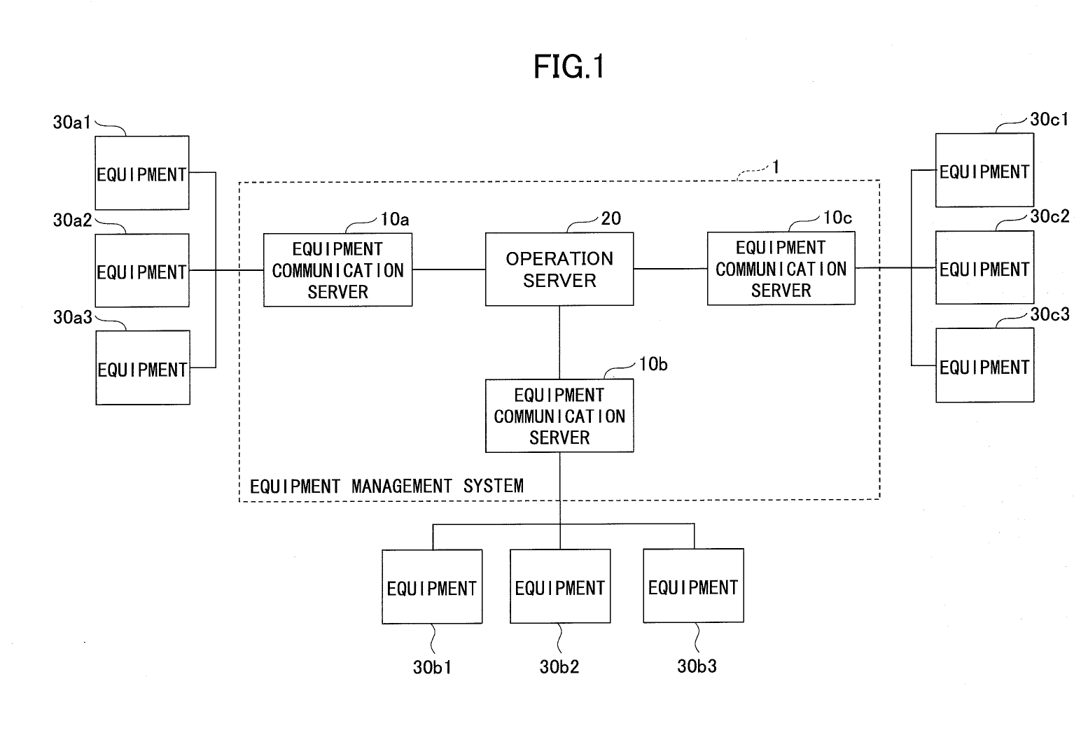

A description will be given of embodiments of the present invention, by referring to the drawings. FIG. 1 is a block diagram illustrating an example of a configuration of an equipment management system in one embodiment of the present invention. In an equipment management system 1 illustrated in FIG. 1, an operation server 20 and equipment communication servers 10a, 10b, and 10c, are communicably connected via a network, such as a LAN (Local Area Network), a WAN (Wide Area Network), and the like. In addition, each of the equipment communication servers 10a, 10b, and 10c (hereinafter also referred as an “equipment communication server 10”) is communicably connected to one or more equipment 30 via a network, such as a LAN, a WAN, and the like. In the example illustrated in FIG. 1, the equipment communication server 10a is communicably connected to equipment 30a1, 30a2, and 30a3, the equipment communication server 10b is communicably connected to equipment 30b1, 30b2, and 30b3, and the equipment communication server 10c is communicably connected to equipment 30c1, 30c2, and 30c3.

The operation server 20 may be formed by a computer that functions as a user interface of the equipment management system 1. The operation server 20 may accept a task execution instruction and the like from an operator. The operation server 20 may be operated directly by the user to input the task execution instruction and the like, or the operation server 20 may receive the task execution instruction and the like from a terminal that is connected to the operation server 20 via a network. The operation server 20 may transmit task information related to a task of the task execution instruction to each equipment communication server 10. The task may refer to a process that is executed for the purposes of maintenance, management, or the like of the equipment 30. Examples of the task may include collecting information from the equipment 30, installing a program into the equipment 30, setting parameters with respect to the equipment 30, and the like. A task execution timing may be instructed by the task execution instruction, for example.

Each equipment communication server 10 may communicate with the equipment 30 that is under management of this equipment communication server 10, and execute the task related to the task information received from the operation server 20 at a timing specified by the task information. The equipment 30 that is under the management of the equipment communication server 10 may refer to the equipment 30 that is connected to the equipment communication server 10 in FIG. 1. List information of the equipment 30 under the management of each equipment communication server 10 is set in each equipment communication server 10.

Each equipment 30 may be formed by an electronic equipment such as an image forming apparatus, a projector, a teleconferencing system, and the like, for example. Of course, the equipment 30 may be formed by a task execution target other than the above described electronic equipment. In addition, although three equipment 30 are connected to each equipment communication server 10 in FIG. 1, the number of equipment 30 connected to one equipment communication server 10 is not limited to three, and for example, the number of equipment connected to one equipment communication server 10 may be several hundred, for example.

In this embodiment, it is assumed for the sake of convenience that the operation server 20 and the equipment communication server 10a are located in Japan, the equipment communication server 10b is located in Germany, and the equipment communication server 10c is located in Brazil. In addition, it is also assumed that each equipment 30 is located in the same region as the equipment communication server 10 that manages the equipment 30. In other words, the equipment communication server 10a and the equipment 30a1 through 30a3, the equipment communication server 10b and the equipment 30b1 through 30b3, and the equipment communication server 10c and the equipment 30c1 through 30c3 belong to mutually different time zones. Further, it is assumed that the operator performs operations in Japan.

Each equipment communication server 10 does not necessarily have to be located in the same time zone as each equipment 30 that is under the management thereof. In addition, each equipment 30 that is under the management of the same equipment communication server 10 does not necessarily have to belong to the same time zone. In a case in which the equipment communication server 10 and the equipment 30 that is under the management thereof are located in mutually different time zones, or in a case in which each equipment 30 belongs to a different time zone, information indicating the time zone of each equipment 30 that is under the management of the equipment communication server 10 may be set in this equipment communication server 10. The time zone may refer to a region in its entirety using a common standard time. In other words, the time zone may refer to the region in its entirety having the same (that is, a common) time difference with respect to UTC (Universal Time, Coordinated).

In FIG. 1, the operation server 20 and the equipment communication server 10 are clearly distinguished from each other. However, one of the equipment communication server 10 may perform the role of the operation server 20. Further, the number of equipment servers 10 may be one, two, or four or more.

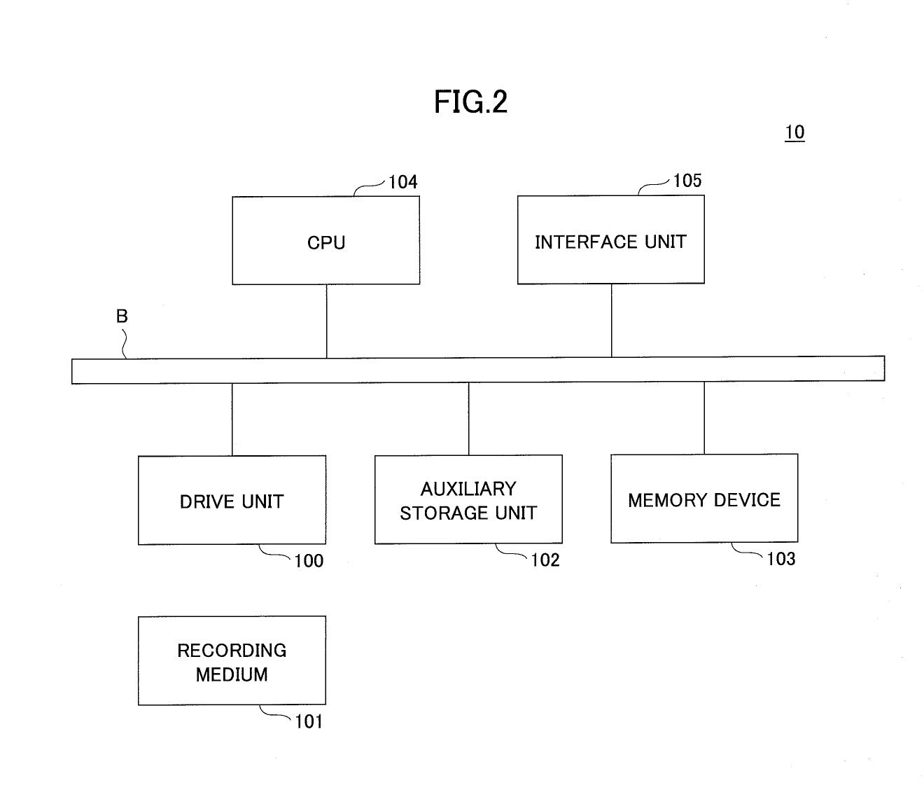

FIG. 2 is a block diagram illustrating an example of a hardware configuration of the equipment communication server in one embodiment of the present invention. The equipment communication server 10 illustrated in FIG. 2 may include a drive unit 100, an auxiliary storage unit 102, a memory device 103, a CPU (Central Processing Unit) 104, and an interface unit 105 that are connected via a bus B.

A program that may enable the process of the equipment communication server 10 may be provided in a form stored in a recording medium 101 such as a CD-ROM (Compact Disk-Read Only Memory). When the recording medium 101 storing the program is set in the drive unit 100, the program may be installed from the recording medium 101 into the auxiliary storage unit 102 via the drive unit 100, under control of the CPU 104. The program does not necessarily have to be installed from the recording medium 101, and for example, the program may be downloaded from another computer or the like via a network. The auxiliary storage unit 102 may store the program installed therein, and various data and the like including files that are required.

In response to a program boot instruction, the program is read from the auxiliary storage unit 102 and stored in the memory device 103 under the control of the CPU 104. The CPU 104 may execute functions related to the equipment communication server 10 according to the program stored in the memory device 103. The interface unit 105 may provide an interface to connect the equipment communication server 10 to a network.

The operation server 20 may have a hardware configuration similar to that illustrated in FIG. 2. In addition, the equipment communication server 10 may have a configuration formed by a plurality of computers.

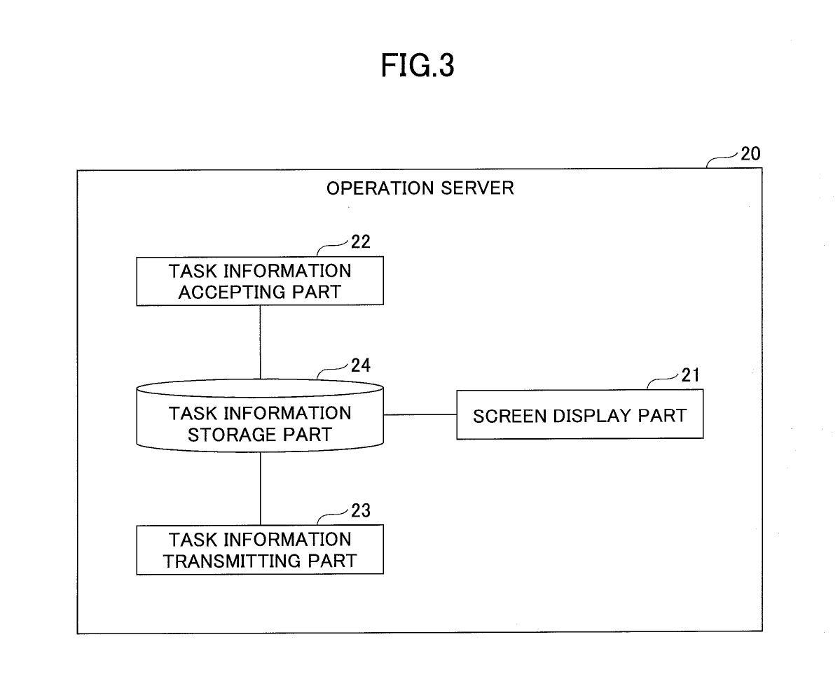

FIG. 3 is a block diagram illustrating an example of a functional configuration of the operation server in one embodiment of the present invention. The operation server 20 illustrated in FIG. 3 may include a screen display part 21, a task information accepting part 22, and a task information transmitting part 23. Functions of these parts 21 through 23 may be performed by the CPU of the operation server 20 when the program installed in the operation server 20 causes the CPU of the operation server 20 to execute the program. The operation server 20 may utilize a task information storage part 24. The task information storage part 24 may be formed by the auxiliary storage unit of the operation server 20, a storage unit connected to the operation server 20 via a network, or the like.

The screen display part 21 may display a screen (hereinafter also referred to as a “task setting screen”) that urges the operator to set a task executing schedule and the like. The task setting screen may be displayed on a terminal that is connected to the operation server 20 via a network, or on a display unit that is connected to the operation server 20.

The task information accepting part 22 may accept the task information, that is set via the task setting screen, and includes the task executing schedule and the like. The task accepting part 22 may store the accepted task information into the task information storage part 24.

The task information transmitting part 23 may transmit the task information stored in the task information storage part 24 to each equipment communication server 10. Address information (for example, an IP (Internet Protocol) address or a URL (Uniform Resource Locator)) or the like of each equipment communication server 10 may be set in advance in the operation server 20.

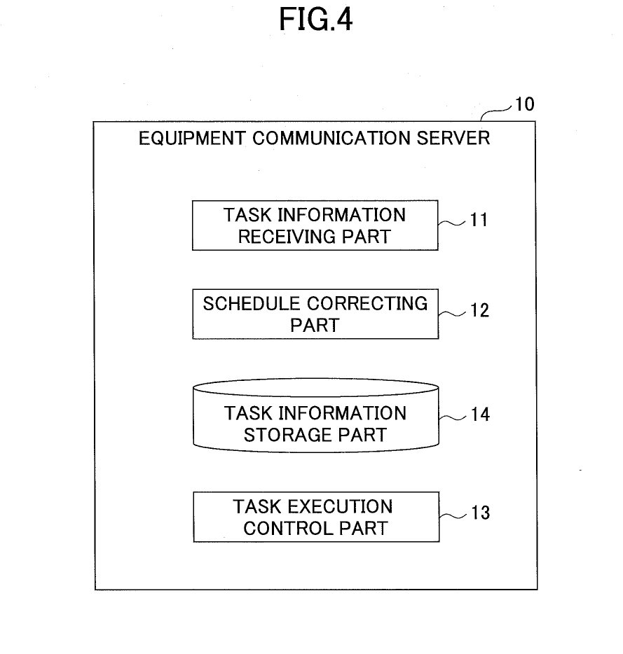

FIG. 4 is a block diagram illustrating an example of a functional configuration of the equipment communication server in one embodiment of the present invention. The equipment communication server 10 illustrated in FIG. 4 may include a task information receiving part 11, a schedule correcting part 12, and a task execution control part 13. Functions of these parts 11 through 13 may be performed by the CPU 14 of the equipment communication server 10 when the program installed in the equipment communication server 10 causes the CPU 104 to execute the program. The equipment communication server 10 may utilize a task information storage part 14. The task information storage part 14 may be formed by the auxiliary storage unit 102, a storage unit connected to the equipment communication server 10 via a network, or the like.

The task information receiving part 11 may receive the task information transmitted from the operation server 20. The schedule correcting part 12 of the equipment communication server 10 may correct a starting time of the task included in the task information to a value suited for the time zone in which the equipment 30 belongs, managed under this equipment communication server 10. The task information storage part 14 may store the task information whose starting time is corrected by the schedule correcting part 12. The task execution control part 13 of the equipment communication server 10 may transmit the task execution instruction to the equipment 30 that is managed under this equipment communication server 10, at a timing indicated by the task information stored in the task information storage part 14.

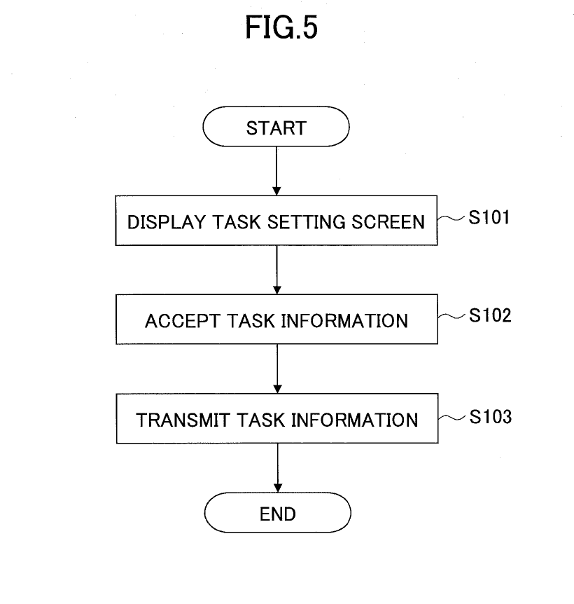

Next, a description will be given of a processing procedure executed by the equipment management system 1, by referring to FIG. 5. FIG. 5 is a flow chart for explaining an example of the processing procedure executed by the operation server.

In step S101 illustrated in FIG. 5, the screen display part 21 may display the task setting screen according to a request from the operator.

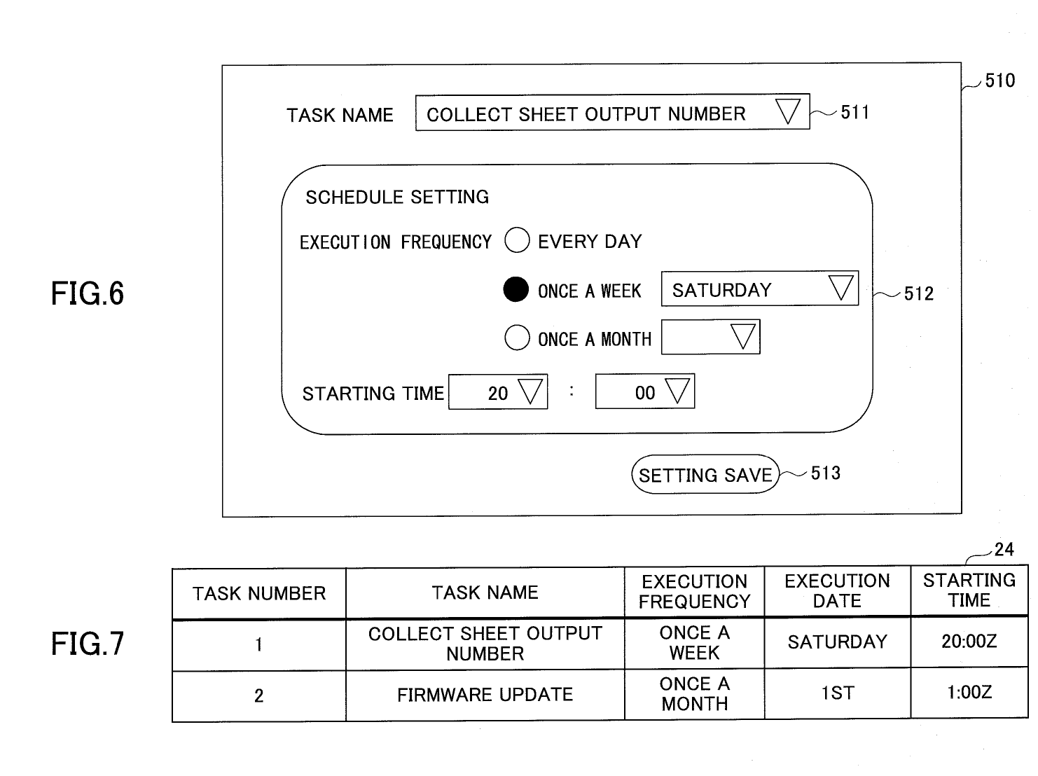

FIG. 6 is a diagram illustrating an example of a display on the task setting screen. A task setting screen 510 illustrated in FIG. 6 includes a task name selecting region 511, a schedule setting region 512, and the like.

Processing contents are predefined in the task name selecting region 511, and a task name of the task that is the execution target may be selected from a plurality of tasks whose task names are displayed in the task name selecting region 511.

Schedule information of the tasks may be set in the schedule setting region 512. FIG. 6 illustrates an example in which an execution frequency and the starting time are set as the schedule information of the tasks. When once a week is selected as the execution frequency, the day of the week is further specified. When once a month is selected as the execution frequency, the date is further specified.

The operator may input, as the starting time, the time when the task is to be executed in the time zone of the operator. For example, when the operator desires the task to be started at a time 20:00 in Japan, the time 20:00 may be set as the starting time. The single setting with respect to the task setting screen 510 may also be valid with respect to the equipment communication servers 10b and 10c belonging to the time zone other than Japan. Hence, the operator does not necessarily have to set the schedule for each time zone to which each equipment 30 belongs.

FIG. 6 illustrates an example in which the information set on the task setting screen 510 includes the task having a task name “collect sheet output number” to be executed at the time 20:00 every Saturday that is set as an execution date. The sheet output number refers to the number of sheets (for example, paper) that are output.

When the operator pushes a setting save button 513 on the task setting screen 510, the task information accepting part 22 may accept the task information whose contents are set on the task setting screen 510, and store the task information in the task information storage part 24 (step S102). When storing the task information in the task information storage part 24, the task information accepting part 22 may treat the starting time of the schedule information included in the task information as UTC time, and not the standard time of the time zone to which the operation server 20 belongs. Treating as the UTC time simply means that the set starting time is interpreted as the time in UTC, and does not mean conversion of the starting time into the UTC time by taking into consideration the time difference between the standard time and the UTC time.

For example, when the operation server 20 is located in Japan and the starting time is set to the time 20:00, the task information accepting part 22 may store the starting time in the task information storage part 24 as the UTC time 20:00 (20:00Z), and not the JST (Japan Standard Time) time 20:00 (20:00+9(JST)). The time 20:00Z corresponds to the JST time 5:00 the next day (that is, the next morning), because the JST is nine (9) hours advanced with respect to UTC. The “Z” of the time “20:00Z” indicates that this time is indicated in UTC.

FIG. 7 is a diagram illustrating an example of a configuration of the task information storage part. The task information storage part 24 illustrated in FIG. 7 may store a task number, the task name, the execution frequency, an execution date, and the starting time of the task information, with respect to each of the set schedules, for example.

The task number may be an identification number allocated to each task information. The values set on the task setting screen 510 may be registered in items of the task information other than the task number. In addition, as described above, the time set on the task setting screen 510 is registered in the starting time as the UTC time.

Next, the task information transmitting part 23 may transmit the task information stored in the task information storage part 24 with respect to each equipment communication server 10 (step S103).

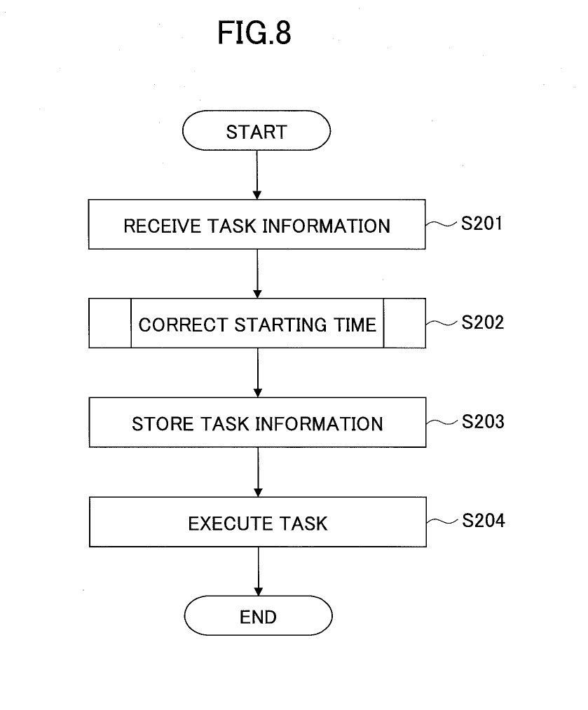

Next, a description will be given of a process executed by the equipment communication server 10, by referring to FIG. 8. FIG. 8 is a flow chart for explaining an example of a processing procedure executed by the equipment communication server.

In step S201 illustrated in FIG. 8, the task information receiving part 11 may receive the task information transmitted in step S103 of FIG. 5. Next, the schedule correcting part 12 may execute a starting time correction process with respect to the starting time included in the task information (step S202). Next, the schedule correcting part 12 may store the task information including the corrected starting time into the task information storage part 14 (step S203). The task information storage part 14 may have a configuration similar to that of the task information storage part 24 illustrated in FIG. 7.

Next, the task execution control part 13 may perform a task execution control based on the task information stored in the task information storage part 14 (step S204). For example, the task execution control part 13 may wait arrival of the times specified by the execution frequency, the execution date, and the starting time included in the task information, in the time zone of the equipment 30 that is under the management of the equipment communication server 10 to which the task execution control part 13 belongs. When the specified time arrives, the task execution control part 13 may transmit a task execution instruction instructing execution of the task having the task name included in the task information, with respect to the equipment 30 that is under the management of the equipment communication server 10 to which the task execution control part 13 belongs.

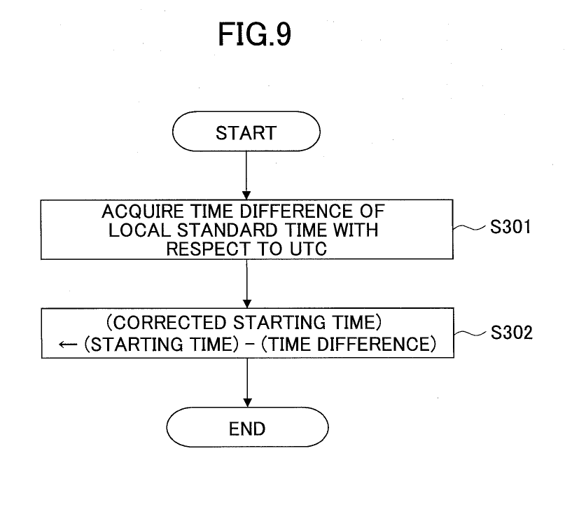

Next, a more detailed description will be given of the process of step S202, by referring to FIG. 9. FIG. 9 is a flow chart for explaining an example of a processing procedure of the start time correction process.

In step S301 illustrated in FIG. 9, the schedule correcting part 12 may acquire the time difference of a local standard time with respect to the UTC. In this embodiment, the local standard time may refer to the standard time of the time zone to which the equipment 30 belongs, which equipment 30 is under the management of the equipment communication server 10. For example, in the case of the equipment communication server 10c, the Brazil standard time may be the local standard time. For example, the time difference of the local standard time with respect to the UTC may be prestored in the auxiliary storage unit 102, or may be compute based on information acquired from an OS (Operating System) or the like of the equipment communication server 10. The time difference of the Brazil standard time with respect to the UTC is “−3:00”, where the minus sign “−” indicates a delay with respect to the UTC. In other words, in this embodiment, the value of the time difference also includes information indicating whether the local standard time is delayed or advanced with respect to the UTC, by the minus sign “−” or the plus sign “+” added in front of the time difference value.

Next, the schedule correcting part 12 may set, as the corrected starting time, a value that is obtained by subtracting the time difference from the starting time of the schedule information (step S302). For example, in the case of the equipment communication server 10c, the time difference is “−3:00”. Hence, with respect to a task 1 having the task number 1 in FIG. 7, 20:00Z−(−3:00)=23:00Z is computed. This value 23:00Z is stored in the task information storage part 14 as the corrected starting time.

In other words, the corrected starting time stored in the task information storage part 14 may indicate that the task 1 is to be executed at the UTC time 23:00Z. The time 23:00Z is the UTC time when the Brazil standard time is 20:00. Accordingly, in this case, the corrected starting time stored in the task information storage part 14 indicates that the task 1 is to be executed at the Brazil standard time 20:00.

Processes similar to that of the equipment communication server 10c described above may be executed in the equipment communication servers 10b and 10b. Accordingly, the task 1 may be executed at the Japan standard time 20:00 and at the Germany standard time 20:00.

In this embodiment, it is a precondition that the task execution control part 13 interprets the starting time stored in the task information storage part 14 as the UTC time. In other words, the corrected starting time (starting time after the correction) is interpreted as the UTC time, and not as the local standard time. In a case in which the task execution control part 13 is to interpret the starting time stored in the task information storage part 14 as the local standard time, the time difference of the local standard time with respect to the UTC may be added to the corrected starting time. In this case, the time that is obtained as a result of this addition of the time difference may be stored in the task information storage part 14. For example, in the case of the BRST (Brazil Standard Time), 23:00Z+(−3:00)=20:00−3(BRST) may be stored as the starting time in the local standard time.

In addition, although the equipment communication server 10 performs the schedule management of the tasks in this embodiment, each equipment 30 may perform the schedule management of the tasks. In other words, each equipment 30 may execute the processes described above in conjunction with FIGS. 8 and 9. In this case, the task information may be distributed from the operation server 20 with respect to each equipment 30, or the task information may be distributed with respect to each equipment 30 via each equipment communication server 10.

Moreover, in this embodiment, the starting time set by the operator is treated as the UTC time and stored in the task information storage part 24. However, the starting time does not necessarily have to be treated as the UTC time. The starting time set by the operator may be treated as a standard time of a particular time zone, as long as it is clear that the starting time is in the standard time of the particular time zone. For example, the starting time set by the operator may be treated as the time in JST.

In this case, in the starting time correction process illustrated in FIG. 9, the time difference of the local standard time with respect to the JST may be computed. Next, this time difference is subtracted from the starting time. In a case in which the task execution control part 13 interprets the starting time stored in the task information storage part 14 as the time in JST, the computed time that is computed by subtracting the time difference from the starting time may be stored in the task information storage part 14 as the starting time. In a case in which the task execution control part 13 interprets the starting time stored in the task information storage part 14 as the time in UTC, the time difference (+9) of the JST with respect to the UTC may be subtracted from the computed time.

For example, the BRST has a time difference of −12 hours with respect to the JST. Hence, in a case in which the starting time is set as 20:00 in BRST, the corrected starting time becomes 8:00 in JST by computing 20−12=8. Furthermore, when converting this starting time into UTC time, the starting time becomes 23:00 in UTC by computing 8−9=23.

In a region where the summer time (or daylight saving time) is introduced, the time difference between the UTC and the local time becomes different between the summer time and times other than the summer time. Accordingly, in such a region, the time difference with respect to the UTC may be varied in step S301 depending on whether the season is the summer time. For example, information indicating the summer time may be stored in the auxiliary storage unit 102, and the judgement to determine whether the season is the summer time may be performed based on this information stored in the auxiliary storage unit 102.

As described above, according to this embodiment, when the operator sets the time at which the task is to be executed in the time zone to which the operator belongs, for example, the task is executed at the set time in the standard time of each time zone. For this reason, it is possible is to simplify the operation of setting the schedule of the process that is to be executed spanning time zones. For example, the operator does not need to compute the time at night and the like for each of the time zones to which each of the equipment 30 belongs. In addition, in a case in which the task is to be executed in one operation with respect to a plurality of equipment 30 belonging to mutually different time zones, it becomes easy to avoid the task from being executed while the general user is accessing the equipment 30 in one of the time zones.

In this embodiment, the equipment communication server 10 may form an example of an information processing apparatus and an information processing system. The UTC may form an example of a standard time in a first time zone. The local standard time may form an example of a standard time in a second time zone. The task information accepting part 22 or the task information receiving part 11 may form an example of a receiving part. The schedule correcting part 12 may form an example of a computing part. The task execution control part 13 may form an example of an executing part.

The present invention can be implemented in any convenient form, for example, using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP (Wireless Application Protocol) or 3G-compliant phone) and so on. Since the present invention can be implemented as software, each and every aspect of the present invention thus encompasses computer software implementable on a programmable device.

The computer software can be provided to the programmable device using any storage medium for storing processor readable code such as a floppy disk, a hard disk, a CD-ROM, a magnetic tape device or a solid state memory device.

The hardware platform includes any desired hardware resources including, for example, a CPU, a RAM (Random Access Memory), and a HDD (Hard Disk Drive). The CPU may include processors of any desired type and number. The RAM may include any desired volatile or nonvolatile memory. The HDD may include any desired nonvolatile memory capable of recording a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

Further, the present invention is not limited to these embodiments, but various variations and modifications may be made without departing from the scope of the present invention.

What is claimed is:

1. An information processing apparatus comprising:
an accepting part configured to accept an execution instruction of a process having a first time specified in a first time zone;
a computing part configured to compute a second time in the first time zone at the first time in a second time zone, based on a time difference between a standard time of the second time zone at which the process is to be executed and a standard time of the first time zone; and
an executing part configured to execute the process when the second time arrives in the first time zone.

2. The information processing apparatus as claimed in claim 1, wherein the computing part computes, as the second time, a value that is obtained by subtracting, the time difference between the standard time of the second time zone at which the process is to be executed and the standard time of the first time zone, from the first time of the first time zone.

3. The information processing apparatus as claimed in claim 2, wherein the computing part computes the second time for each of a plurality of processes to be executed.

4. The information processing apparatus as claimed in claim 1, wherein the computing part computes the second time in the second time zone at the first time in the first time zone, by varying the time difference during daylight saving time.

5. An information processing system comprising:
an accepting part configured to accept an execution instruction of a process having a first time specified in a first time zone;
a computing part configured to compute a second time in the first time zone at the first time in a second time zone, based on a time difference between a standard time of the second time zone at which the process is to be executed and a standard time of the first time zone; and
an executing part configured to execute the process when the second time arrives in the first time zone.

6. The information processing system as claimed in claim 5, wherein the computing part computes, as the second time, a value that is obtained by subtracting, the time difference between the standard time of the second time zone at which the process is to be executed and the standard time of the first time zone, from the first time of the first time zone.

7. The information processing system as claimed in claim 6, wherein the computing part computes the second time for each of a plurality of processes to be executed.

8. The information processing system as claimed in claim 1, wherein the computing part computes the second time in the second time zone at the first time in the first time zone, by varying the time difference during daylight saving time.

9. An information processing method comprising:
accepting an execution instruction of a process having a first time specified in a first time zone;
computing a second time in the first time zone at the first time in a second time zone, based on a time difference between a standard time of the second time zone at which the process is to be executed and a standard time of the first time zone; and
executing the process when the second time arrives in the first time zone.

10. The information processing method as claimed in claim 9, wherein the computing computes, as the second time, a value that is obtained by subtracting, the time difference between the standard time of the second time zone at which the process is to be executed and the standard time of the first time zone, from the first time of the first time zone.

11. The information processing method as claimed in claim 10, wherein the computing computes the second time for each of a plurality of processes to be executed.

12. The information processing method as claimed in claim 9, wherein the computing computes the second time in the second time zone at the first time in the first time zone, by varying the time difference during daylight saving time.
